(19) United States
(12) Patent Application Publication
(10) Pub. No.: US 2006/0087964 A1
(43) Pub. Date: Apr. 27, 2006

(54) Method and apparatus for switching among different network paths while suppressing ghost packets

(75) Inventor: Kenneth Michael Valk, Rochester, MN (US)

Correspondence Address: IBM CORPORATION;ROCHESTER IP LAW DEPT 917, 3605 HIGHWAY 52 N, ROCHESTER, MN, 55901-7829, US

(73) Assignee: International Business Machines Corporation, Armonk, NY (US)

(21) Appl. No.: 10/970,406

(22) Filed: Oct. 21, 2004

(51) Int. Cl. H04L 1/00

(52) U.S. Cl. 370/218; 370/228

(57) ABSTRACT

A method and apparatus are provided for switching among different network paths while suppressing ghost packets. A single path through the network for a destination endpoint is established for accepting packets from each source endpoint. Control packets are provided for changing to an alternate path through the network. Before using an alternate path, all buffered packets with a matching source and destination pair in the alternate path are deleted.

### FIELD OF THE INVENTION

The present invention relates generally to the data processing field, and more particularly, relates to a method and apparatus for switching among different network paths while suppressing ghost packets.

### DESCRIPTION OF THE RELATED ART

Networks often have redundant paths between endpoints in order to allow the network to survive the failure of one or more components. When switching to an alternate path on the network, there is the possibility of packets being stuck on the original path; these packets are called ghost packets.

If these ghost packets become unstuck at the wrong time, they can reach the destination endpoint and take the place of legitimate packets being transmitted on the alternate path.

One known solution to the problem of ghost packets replacing legitimate packets provides a packet life timer that kills a packet that exists for too long and controls alternate route switching such that all potential ghost packets are killed before any new packets are sent on an alternate route. This solution requires an additional field in the packets to hold the life timer and a life timer delay before the alternate route swichover.

A need exists for an improved mechanism for switching among different network paths while suppressing ghost packets.

### SUMMARY OF THE INVENTION

A principal aspect of the present invention is to provide a method and apparatus for switching among different network paths while suppressing ghost packets. Other important aspects of the present invention are to provide such method and apparatus for switching among different network paths while suppressing ghost packets substantially without negative effect and that overcome many of the disadvantages of prior art arrangements.

In brief, a method and apparatus are provided for switching among different network paths while suppressing ghost packets. A single path through the network for a destination endpoint is established for accepting packets from each source endpoint. Control packets are provided for changing to an alternate path through the network. Before using an alternate path, all buffered packets with a matching source and destination pair in the alternate path are deleted.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a block diagram illustrating an exemplary processor system for implementing methods for switching among different network paths while suppressing ghost packets in accordance with the preferred embodiment;

FIG. 2 is a block diagram illustrating exemplary alternate network paths in the processor system of FIG. 1 in accordance with the preferred embodiment;

FIGS. 3A, 3B, and 3C are packet flow diagrams illustrating prior art ghost packet problems;

FIGS. 4A, 4B, and 4C are packet flow diagrams illustrating ghost packet solutions in accordance with the preferred embodiment;

FIGS. 5A, 5B, 5C, 5D, and 5E are flow charts illustrating exemplary steps for implementing methods for switching among different network paths while suppressing ghost packets in accordance with the preferred embodiment; and

FIG. 6 is a block diagram illustrating a computer program product in accordance with the preferred embodiment.

### DETAILED DESCRIPTION OF THE PREFERRED EMBODIMENTS

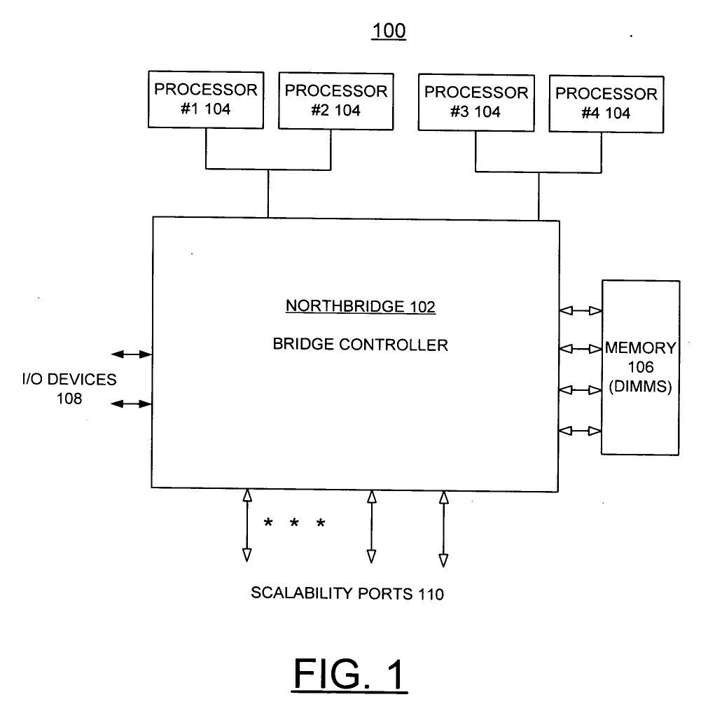

Having reference now to the drawings, in FIG. 1, there is shown an exemplary processor system generally designated by the reference character 100 for implementing method for switching among different network paths while suppressing ghost packets in accordance with the preferred embodiment. Processor system 100 includes a Northbridge controller 102 or other bridge controller containing apparatus for switching among different network paths while suppressing ghost packets in accordance with the preferred embodiment. Northbridge controller 102 includes a processor bus interface for attaching a plurality of processors 104, such as processors #1-4, 102, a memory interface connecting to a memory 106, such as Dual In-line Memory Modules (DIMMs), an I/O interface 108 connecting to I/O devices and a plurality of scalability ports 110. The scalability ports 110 connect to other Northbridge controller chips. For example, scalability ports 110 can connect to 8 other Northbridge controller chips to create a 32-processor system 100.

It should be understood that the present invention is not limited to the illustrated processor system 100 and is applicable to various system configurations; for example, memory 106 can be directly connected to the processors 104.

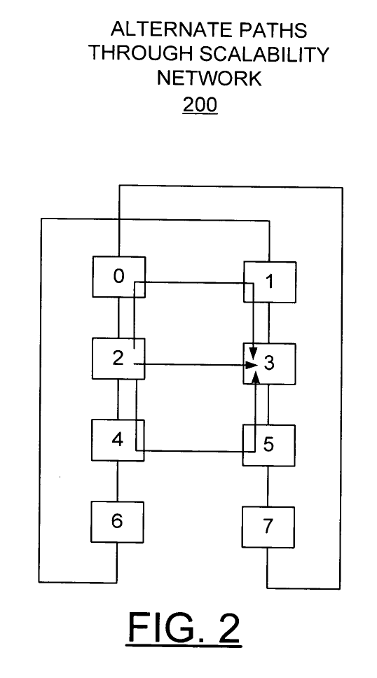

Referring to FIG. 2, there are shown exemplary alternate paths through the scalability network generally designated by the reference character 200 for implementing methods in accordance with the preferred embodiment. For increased reliability Northbridge controller 102 maintains alternate paths 200 through the network. As shown in FIG. 2, packets being sent from node 2 to node 3 typically follow a direct link between nodes 2 and 3. If the direct link fails, there are alternate routes going up through nodes 0 and 1 and down through nodes 4 and 5.

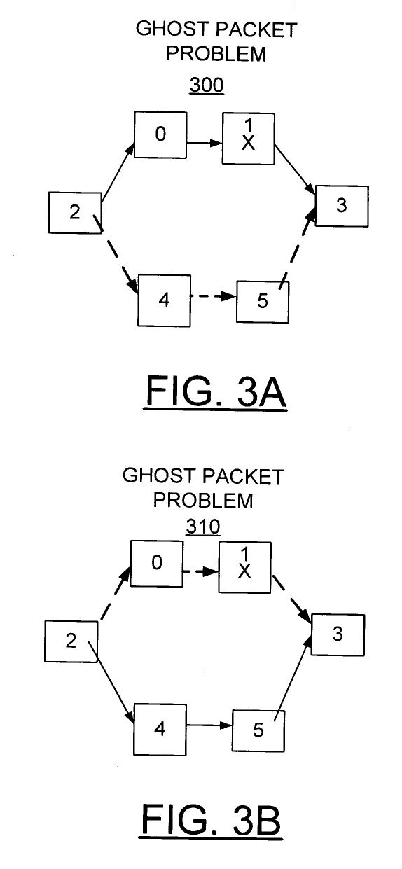

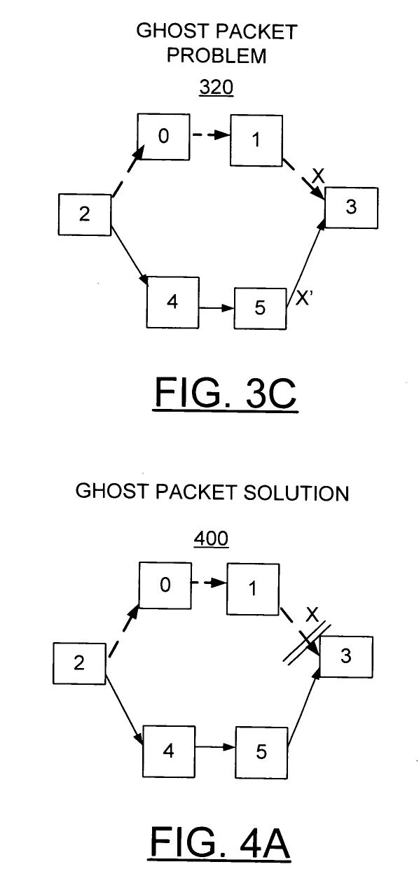

FIGS. 3A, 3B, and 3C are packet flow diagrams illustrating prior art ghost packet problems. In FIG. 3A, a first packet flow diagram generally designated by reference character 300 is shown with packets flowing on an upper path between nodes 2 and 3 as indicated by solid arrows including nodes 0 and 1 when the path fails and packet X is caught in a buffer at node 1. In FIG. 3B, a second packet flow diagram generally designated by reference character 310 is shown when a timeout occurs, and then the packets flow on a lower path between nodes 2 and 3 including nodes 4 and 5 and packet X is still in the top path buffer at node 1. In FIG. 3C, a third packet flow diagram generally designated by reference character 320 is shown when after enough packets on the lower path the end-to-end sequence numbers wrap around back to the sequence number of packet X. Just before packet X′ makes it to the destination node packet X gets out of the buffer, taking the place of packet X′. Packet X is accepted and executed twice while packet X′ is not accepted or executed at all.

In accordance with features of the preferred embodiment, control packets are used when changing to an alternate path through the network. The control packets are used to implement the following: First a destination endpoint accepts packets from only one path through the network for each source endpoint. Before using an alternate path all packets with a matching source/destination pair are killed.

Advantages of methods of the preferred embodiment are that the need for extra life timer field in packets is eliminated and also the need for a maximum life timer delay to alternate path switchover is eliminated.

In accordance with features of the preferred embodiment, the following restrictions are placed on the network: Each primary path and alternate path between a source/destination pair starts on a unique port on the source endpoint, and ends on a unique port on the destination endpoint. A destination endpoint accepts packets from a particular source endpoint on only one of its ports at a time.

In accordance with features of the preferred embodiment, the following sequence is used to change to an alternate path: A clearpath packet is sent from the source endpoint to the destination endpoint using the new alternate path. As the clearpath packet travels through the network, the clearpath packet kills all packets with a matching source/destination pair it encounters. When the destination endpoint receives the clearpath packet, the destination endpoint sends a clearpath-ack packet back to the source endpoint. As the clearpath-ack packet travels through the network, the clearpath-ack packet kills all ack packets with a matching source/destination pair it encounters. At this point, no potential ghost packets exist on the new alternate path. Upon receiving the clearpath-ack packet, the source endpoint sends a MakeCurrent packet to the destination endpoint using the new alternate path.

When the destination endpoint receives the MakeCurrent packet the destination endpoint stops accepting packets from the source endpoint on the port connected to the old path; copies any relevant information, for example, sequence numbers, from the port connected to the old path to the port connected to the new path; starts accepting packets from the source endpoint on the port connected to the new path; and sends an IsCurrent packet back to the source endpoint using the new path. When the source endpoint receives the IsCurrent packet, the source endpoint takes all pending packets for the destination endpoint and transmits or retransmits all pending packets on the new alternate path.

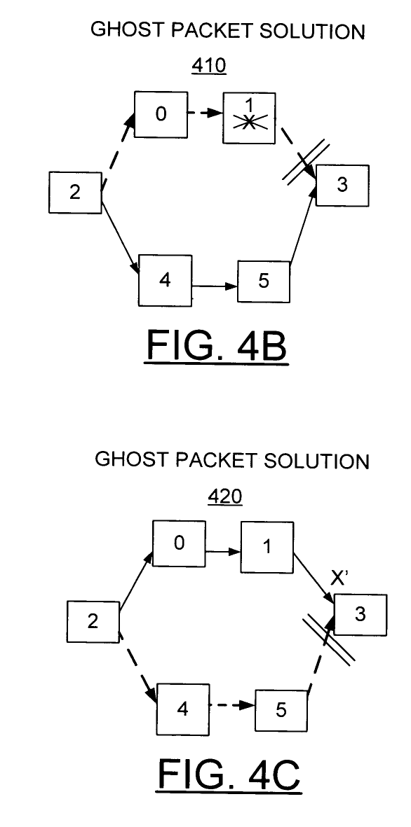

FIGS. 4A, 4B, and 4C illustrate ghost packet solutions in accordance with the preferred embodiment. In accordance with features of the preferred embodiment, only one port may receive packet from a particular node Id at a time. FIG. 4A illustrates a packet flow diagram generally designated by reference character 400 of the preferred embodiment. In packet flow diagram 400 when switching from the top to bottom path the source endpoint node 2 sends control packets to destination endpoint node 3 to set the current port so that when the ghost packet X reaches the destination endpoint node it is dropped. Packet X is not accepted or executed while packet X′ survives and is accepted and executed.

FIG. 4B illustrates a packet flow diagram generally designated by reference character 410 of the preferred embodiment. In packet flow diagram 410 when switching back to the top path, before switching maintenance packets clean out old packets from the new path. Thus packet X is deleted before the new path is re-enabled.

FIG. 4C illustrates a packet flow diagram generally designated by reference character 420 of the preferred embodiment. In packet flow diagram 420 because packet X was deleted before the new path is re-enabled, packet X is prevented from taking the place of packet X′.

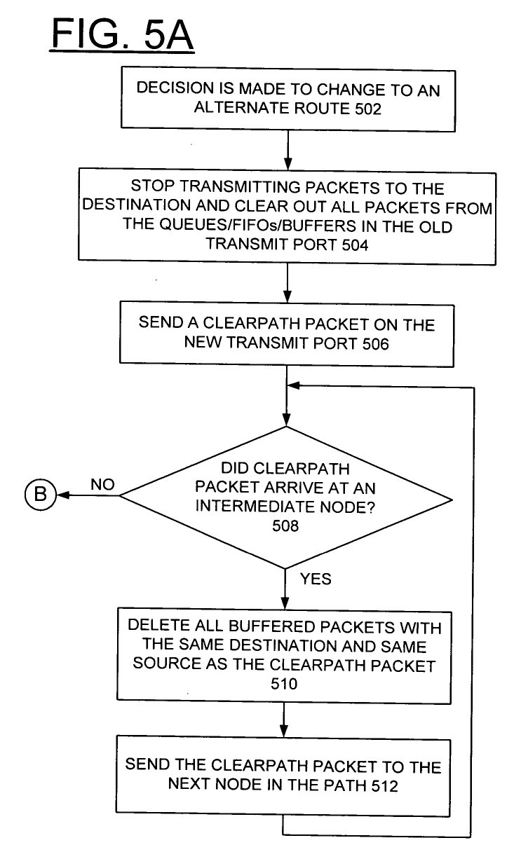

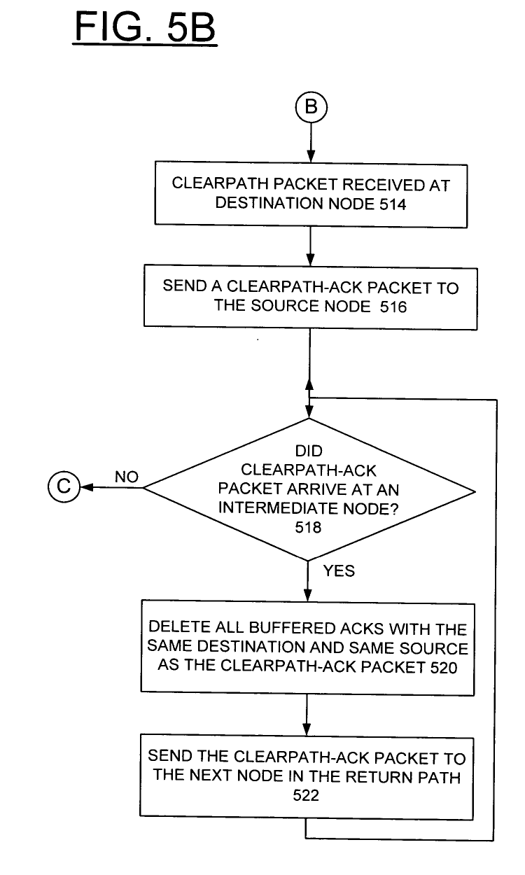

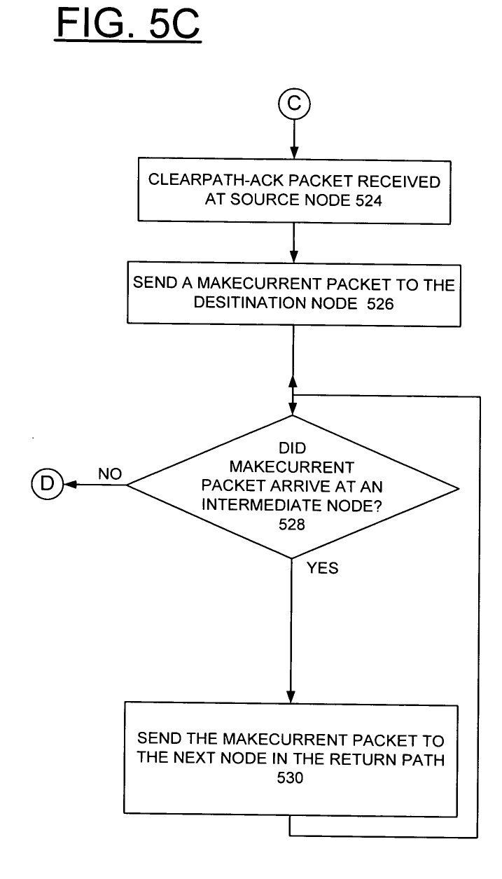

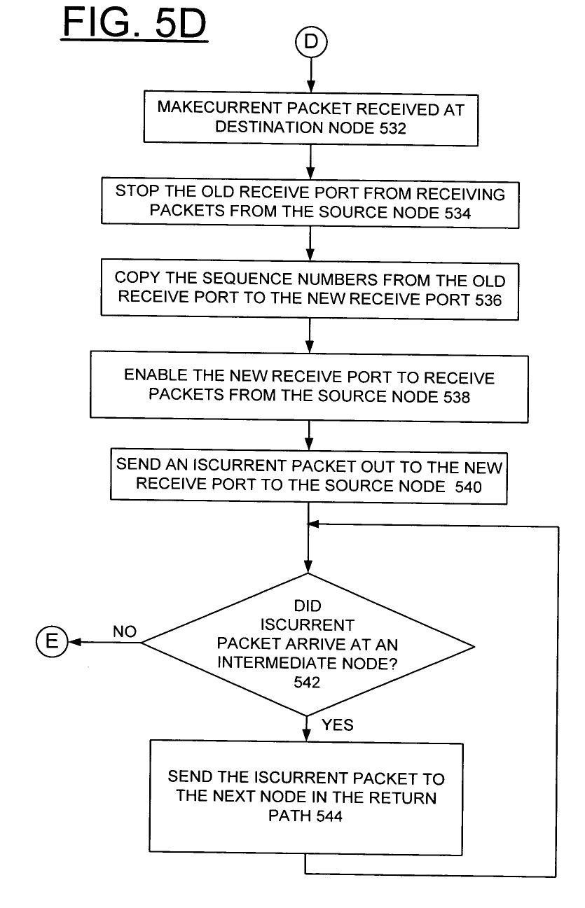

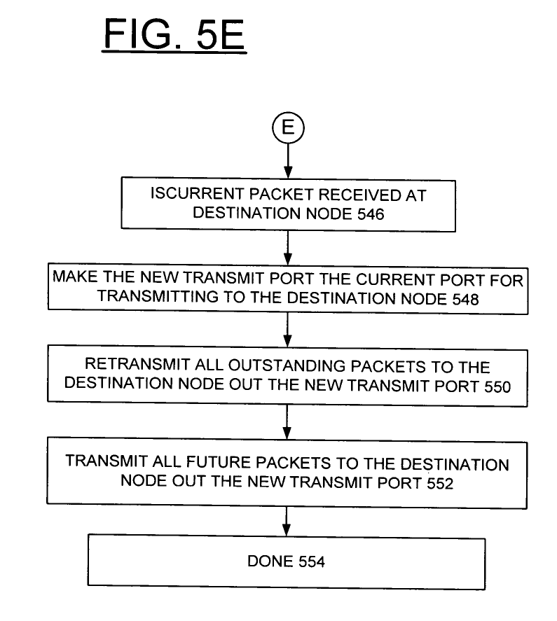

Referring to FIGS. 5A, 5B, 5C, 5D, and 5E, there are shown exemplary steps for implementing methods for switching among different network paths while suppressing ghost packets in accordance with the preferred embodiment.

In FIG. 5A, first a decision is made to change to an alternate route as indicated in a block 502. Then transmitting packets to the destination is stopped and all packets are cleared from the queues, first-in first-out buffers (FIFOs), and buffers in the old transmit path as indicated in a block 504. Then a clearpath packet is sent on the new transmit port as indicated in a block 506. Checking whether the clearpath packet arrived at an intermediate node is performed as indicated in a decision block 508. If the clearpath packet arrived at an intermediate node, then all buffered packets with the same destination and same source as the clearpath packet are deleted as indicated in a block 510. Then the clearpath packet is sent to the next node in the path as indicated in a block 512. Otherwise if determined that the clearpath packet did not arrive at an intermediate node, then the sequential steps continue following entry point B in FIG. 5B.

Referring to FIG. 5B, following entry point B, the clearpath packet arrived at the final destination node as indicated in a block 514, then a clearpath-acknowledge (clearpath-ack) packet is sent to the source node as indicated in a block 516. Checking whether the clearpath-ack packet arrived at an intermediate node is performed as indicated in a decision block 518. If the clearpath-ack packet arrived at an intermediate node, then all buffered ack packets with the same destination and same source as the clearpath-ack packet are deleted as indicated in a block 520. Then the clearpath-ack packet is sent to the next node in the path as indicated in a block 522. Otherwise if determined that the clearpath-ack packet did not arrive at an intermediate node, then the sequential steps continue following entry point C in FIG. 5C.

Referring to FIG. 5C, following entry point C, the clearpath-ack packet arrived at the final destination node as indicated in a block 524, then a MakeCurrent packet is sent to the destination node as indicated in a block 526. Checking whether the MakeCurrent packet arrived at an intermediate node is performed as indicated in a decision block 528. If the MakeCurrent packet arrived at an intermediate node, then the MakeCurrent packet is sent to the next node in the path as indicated in a block 530. Otherwise if determined that the MakeCurrent packet did not arrive at an intermediate node, then the sequential steps continue following entry point D in FIG. 5D.

Referring to FIG. 5D, following entry point D, the MakeCurrent packet arrived at the final destination node as indicated in a block 532, then the old receive port is stopped from receiving packets from the source node as indicated in a block 534. The sequence numbers are copied from the old receive port to the new receive port as indicated in a block 536. Then the new receive port is enabled to receive packets from the source node as indicated in a block 538. Then an IsCurrent packet is sent to the source node as indicated in a block 540. Checking whether the IsCurrent packet arrived at an intermediate node is performed as indicated in a decision block 542. If the IsCurrent packet arrived at an intermediate node, then the IsCurrent packet is sent to the next node in the path as indicated in a block 544. Otherwise if determined that the IsCurrent packet did not arrive at an intermediate node, then the sequential steps continue following entry point E in FIG. 5E.

Referring to FIG. 5E, following entry point E, the IsCurrent packet arrived at the final destination node as indicated in a block 546, then the new transport port is made the current port for transmitting to the destination node as indicated in a block 548. Then all outstanding packets are retransmitted to the destination node out the new transport port as indicated in a block 550. Then future packets are transmitted to the destination node out the new transmit port as indicated in a block 552. Then the exemplary steps are completed as indicated in a block 554.

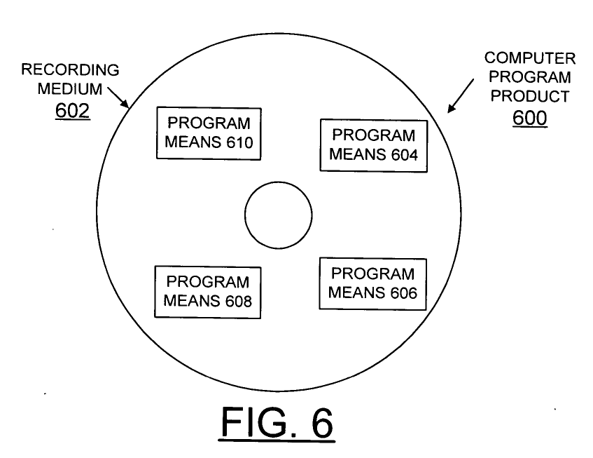

Referring now to FIG. 6, an article of manufacture or a computer program product 600 of the invention is illustrated. The computer program product 600 includes a recording medium 602, such as, a floppy disk, a high capacity read only memory in the form of an optically read compact disk or CD-ROM, a tape, a transmission type media such as a digital or analog communications link, or a similar computer program product. Recording medium 602 stores program means 604, 606, 608, 610 on the medium 602 for carrying out the methods for switching among different network paths while suppressing ghost packets of the preferred embodiment in the system 100 of FIG. 1.

A sequence of program instructions or a logical assembly of one or more interrelated modules defined by the recorded program means 604, 606, 608, 610, direct the processor system 100 for implementing methods for switching among different network paths while suppressing ghost packets of the preferred embodiment.

While the present invention has been described with reference to the details of the embodiments of the invention shown in the drawing, these details are not intended to limit the scope of the invention as claimed in the appended claims.

What is claimed is:

1. A method for switching among different network paths through a network while suppressing ghost packets comprising the steps of:
establishing a single path through the network for a destination endpoint for accepting packets from each source endpoint;
providing control packets for changing to an alternate path through the network; and
deleting all buffered packets with a matching source and destination pair in the alternate path before using an alternate path.

2. A method for switching among different network paths as recited in claim 1 wherein the step of establishing a single path through the network for a destination endpoint for accepting packets from each source endpoint includes the steps of providing a unique port for each said source endpoint for starting the single path.

3. A method for switching among different network paths as recited in claim 2 includes the steps of providing a unique port for said destination endpoint for ending the single path.

4. A method for switching among different network paths as recited in claim 1 wherein the step of providing control packets for changing to an alternate path through the network includes the steps of sending a clearpath packet from a new transmit port of one said source endpoint for the alternate path.

5. A method for switching among different network paths as recited in claim 4 includes the steps of an intermediate node in the alternate path receiving said clearpath packet, said intermediate node deleting all buffered packets with said matching source and destination pair and sending said clearpath packet to a next node in the alternate path.

6. A method for switching among different network paths as recited in claim 4 includes the steps of the destination endpoint receiving said clearpath packet; and the destination endpoint sending a clearpath-acknowledge packet to the source endpoint.

7. A method for switching among different network paths as recited in claim 6 includes the steps of an intermediate node in the alternate path receiving said clearpath-acknowledge packet, said intermediate node deleting all buffered acknowledge packets with said matching source and destination pair and sending said clearpath-acknowledge packet to a next node in the alternate path.

8. A method for switching among different network paths as recited in claim 6 includes the steps of the source endpoint receiving said clearpath-acknowledge packet, and the source endpoint sending a makecurrent packet to the destination endpoint.

9. A method for switching among different network paths as recited in claim 8 includes the steps of an intermediate node in the alternate path receiving said makecurrent packet; and said intermediate node sending said makecurrent packet to a next node in the alternate path.

10. A method for switching among different network paths as recited in claim 8 includes the steps of the destination endpoint receiving said makecurrent packet; and the destination endpoint sending an iscurrent packet to the source endpoint.

11. A method for switching among different network paths as recited in claim 10 includes the steps of the source endpoint receiving said iscurrent packet and transmitting all packets from said new transmit port to the destination endpoint.

12. A computer program product for implementing switching among different network paths through a network while suppressing ghost packets in a processor system, said computer program product including instructions executed by the processor system to cause the processor system to perform the steps of:
establishing a single path through the network for a destination endpoint for accepting packets from each source endpoint;
providing control packets for changing to an alternate path through the network; and
deleting all buffered packets with a matching source and destination pair in the alternate path before using an alternate path.

13. A computer program product for implementing switching among different network paths as recited in claim 12 wherein the step of deleting all buffered packets with a matching source and destination pair in the alternate path before using an alternate path includes the steps of the source endpoint sending a clearpath packet from a new transmit port for the alternate path, each intermediate node in the alternate path responsive to receiving said clearpath packet, deleting all buffered packets with said matching source and destination pair and sending said clearpath packet to a next node in the alternate path.

14. Apparatus for switching among different network paths through a network while suppressing ghost packets comprising:
a bridge controller coupled to the network;
said bridge controller for establishing a single path through the network for a destination endpoint for accepting packets from each source endpoint; providing control packets for changing to an alternate path through the network; and deleting all buffered packets with a matching source and destination pair in the alternate path before using an alternate path.

15. Apparatus for switching among different network paths as recited in claim 14 wherein each said source endpoint includes a unique port for starting the single path and said destination endpoint includes a unique port for ending the single path.

16. Apparatus for switching among different network paths as recited in claim 14 wherein said destination endpoint accepts packets from each said source endpoint only on one predefined port at a time.
